(19) United States
(12) Patent Application Publication
(10) Pub. No.: US 2022/0270114 A1
(43) Pub. Date: Aug. 25, 2022

(54) METHOD AND SYSTEM FOR AUTOMATIC LEAD GENERATION BASED ON PUBLIC DOCUMENTS

(71) Applicant: JPMorgan Chase Bank, N.A., New York, NY (US)

(72) Inventors: Simerjot KAUR, Jersey City, NJ (US); Jonathan SHEPARD, New York, NY (US); Sameena SHAH, Scarsdale, NY (US)

(73) Assignee: JPMorgan Chase Bank, N.A., New York, NY (US)

(21) Appl. No.: 17/182,776

(22) Filed: Feb. 23, 2021

(51) Int. Cl. G06Q 30/02; G06F 40/174; G06F 40/279

(52) U.S. Cl. CPC G06Q 30/0201; G06F 40/174; G06F 40/279; G06Q 30/0205

(57) ABSTRACT

A method for automatically generating leads for solicitation of prospective clients is provided. The method includes: accessing identification information that relates to an entity that has registered with a government agency via a web site associated with the agency; automatically downloading a document that the entity has filed with the agency from the web site; extracting additional information from the downloaded document; determining an identity of a target group for solicitation of the entity as a prospective client based on the accessed information and the extracted information; and routing a relevant portion of the information to the target group.

### BACKGROUND

### 1. Field of the Disclosure

This technology generally relates to methods and systems for generating leads for solicitation of new clients, and more particularly, to methods and systems for automatically generating leads for solicitation of prospective clients based on public documents.

### 2. Background Information

In many firms and commercial entities, there is an ongoing need to solicit prospective clients. Often, a firm may solicits prospective clients in an ad-hoc, non-standardized way which could lead to missed opportunities in identifying new clients. In addition, for a financial institution, it may be relatively difficult to obtain business intelligence regarding prospective clients with respect to their managed accounts, private funds, and other information that could potentially lead to other client prospecting opportunities.

Accordingly, there is a need for an improved methodology for automatically generating leads for solicitation of prospective clients based on public documents.

### SUMMARY

The present disclosure, through one or more of its various aspects, embodiments, and/or specific features or sub-components, provides, inter ilia, various systems, servers, devices, methods, media, programs, and platforms for automatically generating leads for solicitation of prospective clients based on public documents.

According to an aspect of the present disclosure, a method for automatically generating leads for solicitation of prospective clients based on public documents is provided. The method is implemented by at least one processor. The method includes: accessing, by the at least one processor, first information that relates to a first entity that has registered with at least one government agency; obtaining, by the at least one processor, a document that the first entity has filed with the at least one government agency; extracting, by the at least one processor, second information from the obtained document; determining, based on the extracted second information, an identity of a target group for solicitation of the first entity as a prospective client; and routing, by the at least one processor, at least a portion of the first information and at least a portion of the second information to the target group.

The accessing of the first information may include accessing a web site that is associated with the at least one government agency. The obtaining of the document may include downloading the document from the web site.

The method may further include using the at least a portion of the first information and the at least a portion of the second information to generate a report that has a predetermined format. The routing may include routing the generated report to the target group.
The document may include a Portable Document Format (PDF) document. The extracting may include using a PDF reader that is configured to extract the second information from the obtained PDF document.

The first information may include at least one from among identification information that relates to the first entity, a location that relates to the first entity, a filing number associated with the government agency, and a central registration depository.

The second information may include at least one from among information that describes a business of the first entity, information that relates to an ownership structure of the first entity, information that identifies at least one client of the first entity, information that identifies at least one affiliation of the first entity, information that relates to an advisory service that is offered by the first entity, and demographic information that relates to the first entity.

The first entity may include an investment adviser firm.

The at least one government agency may include the United States Securities and Exchange Commission (SEC).

The document may include a Form ADV.

The target group may include at least one from among a sales team associated with a financial institution, a marketing team associated with the financial institution, a business intelligence team associated with the financial institution, and a market intelligence team associated with the financial institution.

According to another exemplary embodiment, a computing apparatus for automatically generating a lead for a solicitation of a prospective client is provided. The computing apparatus includes a processor; a memory; and a communication interface coupled to each of the processor and the memory. The processor is configured to: access first information that relates to a first entity that has registered with at least one government agency; obtain a document that the first entity has filed with the at least one government agency; extract second information from the obtained document; determine, based on the extracted second information, an identity of a target group for solicitation of the first entity as a prospective client; and route, via the communication interface, at least a portion of the first information and at least a portion of the second information to the target group.

The processor may be further configured to access the first information via a web site that is associated with the at least one government agency, and to download the document from the web site.

The processor may be further configured to use the at least a portion of the first information and the at least a portion of the second information to generate a report that has a predetermined format, and to route the generated report to the target group.

The document may include a Portable Document Format (PDF) document. The processor may be further configured to use a PDF reader that is configured to extract the second information from the obtained PDF document

The first information may include at least one from among identification information that relates to the first entity, a location that relates to the first entity a filing number associated with the government agency, and a central registration depository.

The second information may include at least one from among information that describes a business of the first entity, information that relates to an ownership structure of the first entity, information that identifies at least one client of the first entity, information that identifies at least one affiliation of the first entity, information that relates to an advisory service that is offered by the first entity, and demographic information that relates to the first entity.

The first entity may include an investment adviser firm.

The at least one government agency may include the United States Securities and Exchange Commission (SEC).

The document may include a Form ADV.

The target group may include at least one from among a sales team associated with a financial institution, a marketing team associated with the financial institution, a business intelligence team associated with the financial institution, and a. market intelligence team associated with the financial institution.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for automatically generating leads for solicitation of prospective clients based on public documents.

FIG. 4 is a flowchart of an exemplary process for implementing a method for automatically generating leads for solicitation of prospective clients based on public documents.

FIG. 5 is an exemplary screen shot of a government web site that relates to information to be extracted in a method for automatically generating leads for solicitation of prospective clients based on public documents, according to an exemplary embodiment.

FIG. 6 is a sample government form that includes publicly available information that is usable in a method for automatically generating leads for solicitation of prospective clients based on public documents, according to an exemplary embodiment.

FIG. 7 is a system architecture diagram for implementing a method for automatically generating leads for solicitation of prospective clients based on public documents, according to ari exemplary embodiment.

FIG. 8 is section of an entity formations file that is generated as an output by executing a method for automatically generating leads for solicitation of prospective clients based on public documents, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

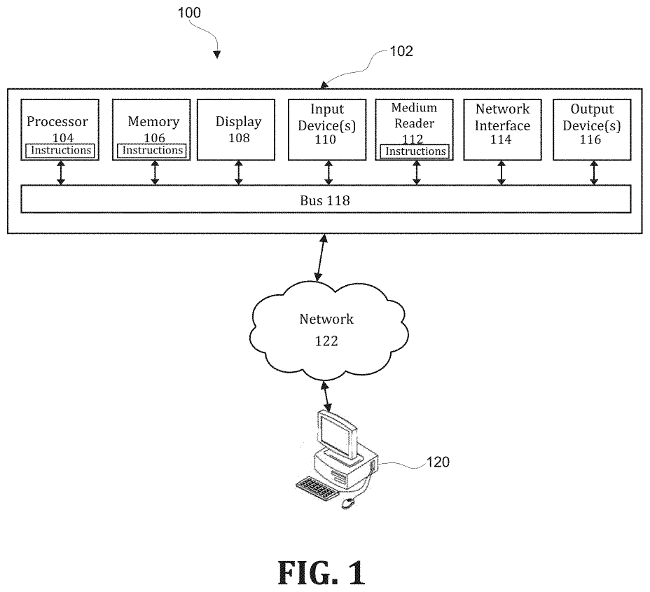

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based. computing environment.

In a networked deployment, the computer system 102 may operate in the capacity of a server or as a client user computer in a server-client user network environment, a client user computerin a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a. wireless smart phone, a personal trusted device, a. wearable device, a global positioning satellite (GPS) device, a web appliance, or any other machine capable of executing a set of instructions (sequential or otherwise) that specify actions be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodimentsherein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both, Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110, Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g, software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via internalan bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automatically generating leads for solicitation of prospective clients based on public documents.

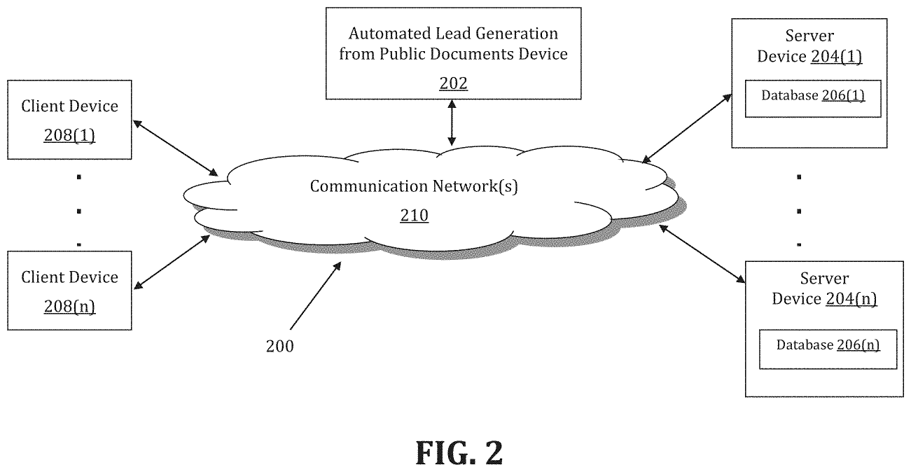

Referring to FIG. 2, a schematic of an exemplary network environment 200 for implementing a method automatically generating leads for solicitation of prospective clients based on public documents is illustrated. In an exemplary embodiment, the method is executable on any networked computer platform, such as, for example, a personal computer (PC).

The method for automatically generating leads for solicitation of prospective clients based on public documents may be implemented by an Automated Lead Generation from Public Documents (ALGPD) device 202. The ALGPD device 202. may be the same or similar to the computer system 102 as described with respect to FIG. 1. The ALGPD device 202 may store one or more applications that can include executable instructions that, when executed by the ALGPD device 202, cause the ALGPD device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(st that may be managed in a cloud-based computing environment. Also, the application(s), and even the ALGPD device 202 itself, may be located in virtual server(s) running in a cloud-based computing environment rather than being tied to one or more specific physical network computing devices. Also, the application(s) may be running in one or more virtual machines (VMs) executing on the ALGPD device 202. Additionally, in one or more embodiments of this technology, virtual machine(s) running on the ALGPD device 202 may be managed or supervised by a hypervisor.

In the network environment 200 of FIG. 2, the ALGPD device 202 is coupled to a plurality of server devices 204(1)-204(n) that hosts a plurality of databases 206(1)-206(n), and also to a plurality of client devices 208(1)-208(n) via communication network(s) 210. A communication interface of the ALGPD device 202, such as the network interface 114 of the computer system 102 of FIG. 1, operatively couples and communicates between the ALGPD device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ALGPD device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ALGPD devices that efficiently implement a method for automatically generating leads for solicitation of prospective clients based on public documents.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ALGPD device 202 may be a standalone device or integrated with one or more other devices or apparatuses, such as one or more of the server devices 204(1)-204(n), for example. In one particular example, the ALGPD device 202 may include or be hosted by one of the server devices 204(1)-204(n), and other arrangements are also possible. Moreover, one or more of the devices of the ALGPD device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ALGPD device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to public documents and business intelligence.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master;/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a. single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ALGPD device 202 via communication networks) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ALGPD device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ALGPD device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ALGPD device 202, the server devices 204(1)-204(4 or the client devices 208(1)-208(n), for example, may be configured to operate as virtual instances on the same physical machine. In other words, one or more of the ALGPD device 202, the server devices 204(1)-204(0, or the client devices 208(1)-208(n) may operate on the same physical device rather than as separate devices communicating through communication network(s) 210. Additionally, there may be more or fewer ALGPD devices 202, server devices 204(1)-204(n), or client devices 208(1)-208(n) than illustrated in FIG, 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

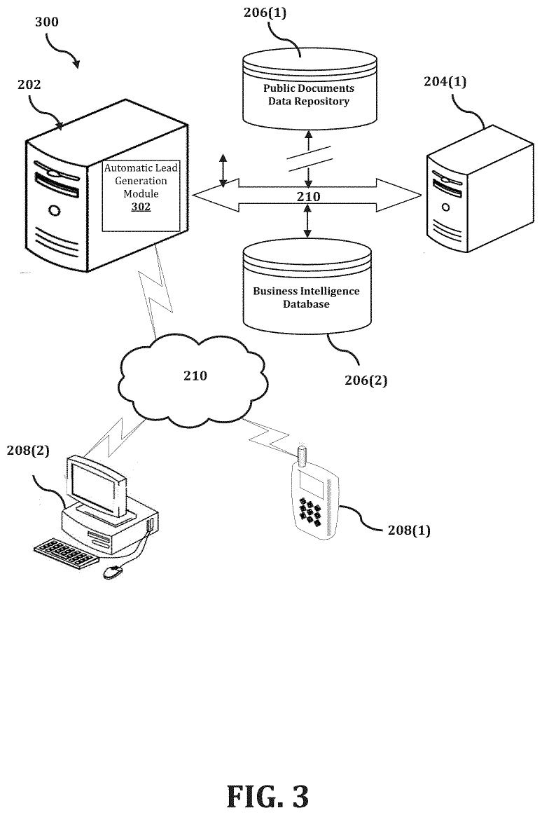

The ALGPD device 202 is described and illustrated in FIG. 3 as including an automatic lead generation module 302, although it may include other rules, policies, modules, databases, or applications, for example. As will be described below, the automatic lead generation module 302 is configured to implement a method for automatically generating leads for solicitation of prospective clients based on public documents.

An exemplary process 300 for implementing a mechanism for automatically generating leads for solicitation of prospective clients based on public documents by utilizing the network environment of FIG. 2 is illustrated as being executed. in FIG. 3, Specifically, a first client device 208(1) and a second client device 208(2) are illustrated as being in communication with ALGPD device 202. In this regard, the first client device 208(1) and the second client device 208(2) may be “clients” of the ALGPD device 202 and are described herein as such. Nevertheless, it is to be known and understood that. the first client device 208(1) and/or the second client device 208(2) need not necessarily be “clients” of the ALGPD device 202, or any entity described in association therewith herein. Any additional or alternative relationship may exist between either or both of the first client device 208(1) and the second client device 208(2) and the ALGPD device 202, or no relationship may exist,

Further ALGPD device 202 is illustrated as being able to access a public documents data repository 206(1) and a business intelligence database 206(2). The automatic lead generation module 302 may be configured to access these databases for implementing a method for automatically generating leads for solicitation of prospective clients based on public documents.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary, embodiment, either or both of the first client device 208(1) and the second client device 208(2) may communicate with the ALGID device 202 via broadband or cellular communication. Of course, these embodiments are merely exemplary and are not limiting or exhaustive.

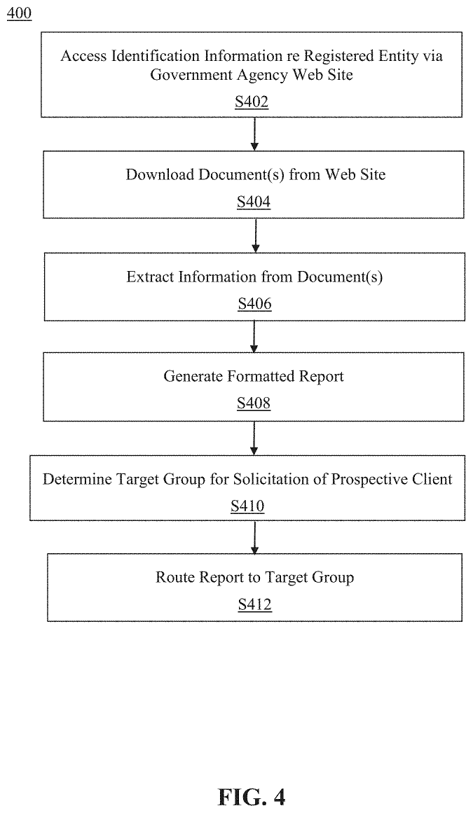

Upon being started, the automatic lead generation module 302 executes a process for automatically generating leads for solicitation of prospective clients based on public documents. An exemplary process for automatically generating leads for solicitation of prospective clients based on public documents is generally indicated at flowchart 400 in FIG. 4.

In process 400 of FIG. 4, at step 5402, the automatic lead generation module 302 accesses information that relates to an entity that has registered with a government agency. In an exemplary embodiment, the information includes identification information, i.e., a name of the entity. The information may also include a location that is associated with the entity, a registration number or filing number associated with the government agency, and/or a central registration depository. The accessing of the information may be performed by accessing a web site that is associated with the government agency.

At step S404, the automatic lead generation module 302 obtains one or more documents that the entity has filed with the government agency. In an exemplary embodiment, the document(s) may be obtained by downloading the documents) from the web site that is associated with the government agency.

In an exemplary embodiment, the entity may be an investment adviser firm, and the government agency may be the United States Securities and Exchange Commission. The documents may include a Form ADV.

At step S406, the automatic lead generation module 302 extracts information from the documents. The documents may be Portable Document Format (PDF) documents. In an exemplary embodiment, the automatic lead generation module 302 may implement a PDF reader that is configured to extract information fr©m PDF documents. The extractable information may include detailed information that is specific to the entity, such as, for example, any one or nore of a business description, ownership structure information, client identification information, affiliations, advisory services offered by the entity, and demographic information.

At step S408, the automatic lead generation module 302 generates a formatted report that includes information that is deemed relevant to a lead for a solicitation of the entity as a prospective client. The report includes information obtained as a result of the web site access performed in step 5402 and the information extraction performed in step S406.

At step S410, the automatic lead generation module 302 uses the information included in the report to determine a target group to which the report is to be delivered. Then, at step S412, the automatic lead generation module 302 routes the report to the target group, In an exemplary embodiment, a financial institution such as a bank may be interested in soliciting prospective clients, and may have several potential target groups within the institution, such as, for example, a sales team, a marketing team, a business intelligence team, and a market intelligence teams. However, other possible target groups may also be determined as recipients of the report,

In an exemplary embodiment, methods and systems for augmenting non-standardized solicitation of prospective clients with an end-to-end autonomous system leveraging public documents must tackle native challenges, including the following: 1) Amount of data available: various kinds of public documents available at government and local business directory websites, various types of demographic information at census websites; and 2) Extraction of relevant information regarding prospective clients from these public documents.

There is a financial benefit to developing a complete end-to-end autonomous system wherein the enormous amount of business intelligence with an overlay of demographic information improves the likelihood of successful interactions and onboarding of many more new clients. There is also a strategic benefit which could lead to better business decisions for a particular firm, such as, for example, entering a new market.

In an exemplary embodiment, a complete autonomous system for soh citing prospective clients by obtaining and extracting information from public documents available at government and local business directory websites is provided. The derived analytics and business intelligence improves the likelihood of identifying new clients that require the services of a service provider and also advance the achievement of goals for the client and the service provider.

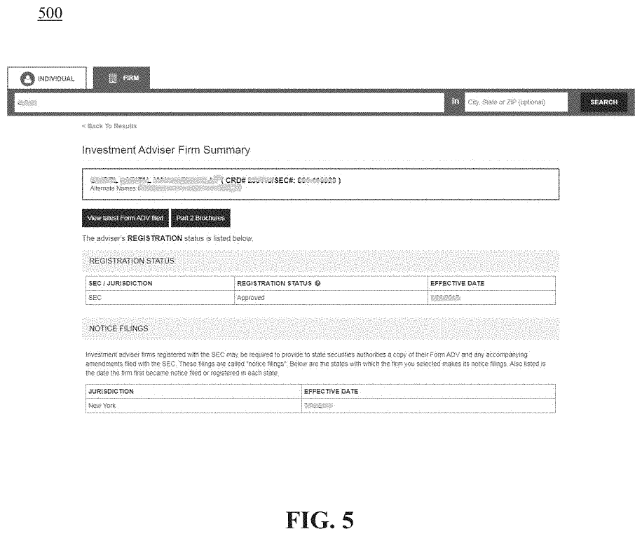

In an exemplary embodiment, the novel solution breaks the problem into sections. First, the automatic lead generation from public documents module 302 automatically downloads a list of registered entities from various government web sites, such as, for example, the Securities and Exchange Commission (SEC), as illustrated in the screenshot 500 shown in FIG. 5, and state government web sites that contain business formation directories that are updated regularly. The web sites provide detailed information, such as each entity's location, SEC filing number, central registration depository, etc.

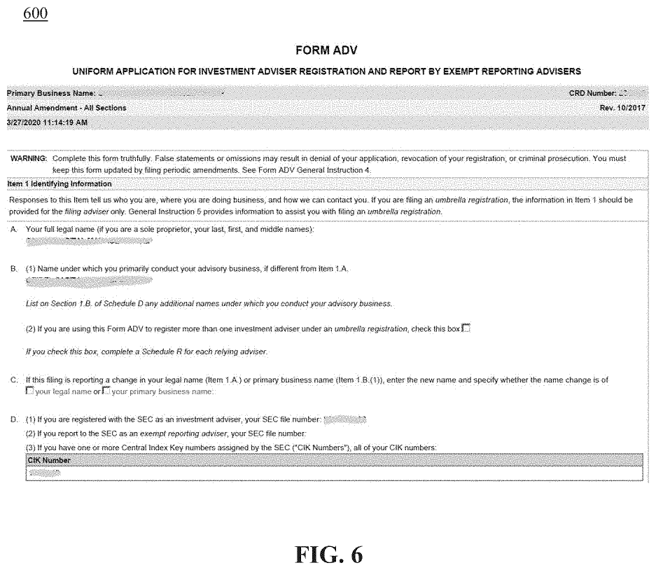

A second section requires categorization of the prospective client and leads to a specific sales team that handles the client segment. For this, referring to FIG. 6, the automatic lead generation module 302 links the prospective client to its SEC Form ADV 600 that is used by investment advisors to register with both the SEC and state securities authorities. The SEC Form ADV is used for disclosing information about the investment adviser's business, ownership structure, clients, and affiliations, as well as available advisory services.

Once the linked SEC Form ADV is obtained, the automatic lead generation module 302 automatically downloads the document, which is a PDF document. In an exemplary embodiment, a PDF reader and extractor engine that is configured for parsing these types of PDF documents is used to automatically extract relevant fields from the document. Fields of interest include information regarding each entity's separately managed accounts, private funds, auditing firms, and prime brokers. Further, the field level information is leveraged to determine the appropriate sales, marketing team, business intelligence, market intelligence and other teams that may be interested in pursuing the lead, and the lead is then routed to them. Additional use cases where this information may be leveraged are also possible.

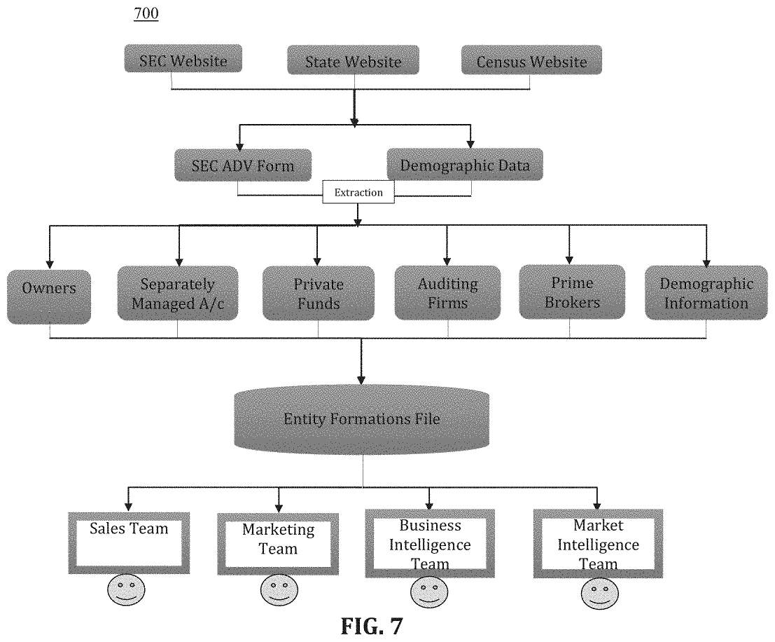

Referring to FIG. 7, a system architecture 700 illustrates how data flows through the pipeline, according to an exemplary embodiment. End users receive an entity formations file on a monthly basis (or any other suitable periodic basis). The entity formations file contains a list of entities together with as relevant business intelligence details. Every month, the automatic lead generation module 302 extracts a new set of entities that have registered with the SEC in the past month. The automatic lead generation module 302 then downloads the ADV forms that have been submitted to the SEC by the registered entities. For each such entity, the extraction tool extracts detailed information related to ownership, separately managed accounts, private funds, auditing firms, prime brokers, and demographic information. The extracted information is then formatted into an entity formations file in which the field level information is leveraged to determine the appropriate sales, marketing, business intelligence, market intelligence, and other teams that may be interested in pursuing the lead.

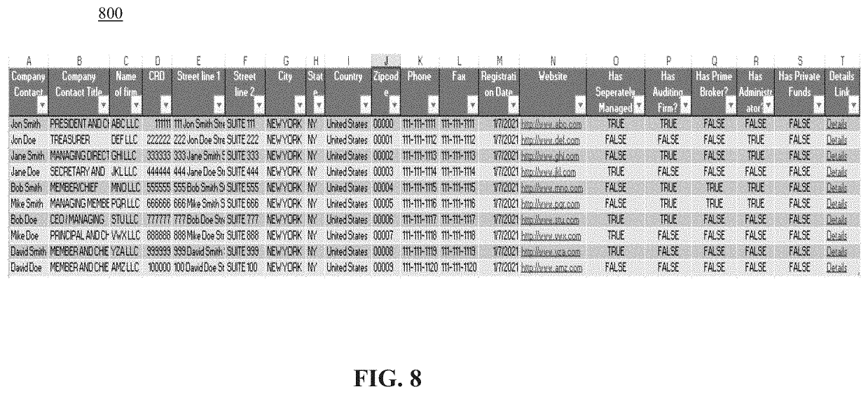

The entity formations file is provided to the users on a periodic basis. In an exemplary embodiment, the file is formatted into sections. Referring to FIG. 8, the first section is the main header sheet 800 containing the entity names, ownership information, demographics and filters on detailed information, for instance if the company ADV form contains any information on its prime brokerage firms.

In an exemplary embodiment, the second section may be accessed by clicking a hyperlink “Details” that corresponds to a specific entity, as shown in column T of main header sheet 800, The second section may contain comprehensive information that corresponds to an investment adviser's business, ownership structure, clients, and affiliations, as well as advisory services offered by the entity.

Accordingly, with this technology, an optimized process for automatically generating leads for solicitation of prospective clients based on public documents is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more ancient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detai led description.

1. A method for automatically generating a lead for a solicitation of a prospective client, the method being implemented by at least one processor, the method comprising:
accessing, by the at least one processor, first information that relates to a first entity that has registered with at least one government agency;
obtaining, by the at least one processor, a document that the first entity has filed with the at least one government agency;
extracting, by the at least one processor, second information from the obtained document;
determining, based on the extracted second information, an identity of a target group for solicitation of the first entity as a prospective client; and
routing, by the at least one processor, at least a portion of the first information and at least a portion of the second information to the target group
wherein the accessing of the first information comprises accessing a web site that is associated with the at least one government agency, and wherein the obtaining of the document comprises automatically downloading the document from the web site.

2. (canceled)

3. The method of claim 1, further comprising using the at least a portion of the first information and the at least a portion of the second information to generate a report that has a predetermined format, wherein the routing comprises routing the generated report to the target group.

4. The method of claim 1, wherein the document includes a Portable Document Format (PDF) document, and wherein the extracting comprises using a PDF reader that is configured to extract the second information from the obtained PDF document.

5. The method of claim 1, wherein the first information includes at least one from among identification information that relates to the first entity, a location that relates to the first entity, a filing number associated with the government agency, and a central registration depository.

6. The method of claim 1, wherein the second information includes at least one from among information that relates to an ownership structure of the first entity, information that identifies at least one client of the first entity, information that identifies at least one affiliation of the first entity, and information that relates to an advisory service that is offered by the first entity.

7. The method of claim 1, wherein the first entity includes an investment adviser firm.

8. The method of claim 7, wherein the at least one government agency includes a United States Securities and Exchange Commission (SEC).

9. The method of claim 8, wherein the document includes a Form ADV.

10. The method of claim 9, wherein the target group includes at least one from among a sales team associated with a financial institution, a marketing team associated with the financial institution, a business intelligence team associated with the financial institution, and a market intelligence team associated with the financial institution.

11. A computing apparatus for automatically generating a lead for a solicitation of a prospective client, the computing apparatus comprising:
a processor;
a memory; and
a communication interface coupled to each of the processor and the memory,
wherein the processor is configured to:
access first information that relates to a first entity that has registered with at least one government agency;
obtain a document that the first entity has filed with the at least one government agency;
extract second information from the obtained document;
determine, based on the extracted second information, an identity of a target group for solicitation of the first entity as a prospective client; and
route, via the communication interface, at least a portion of the first information and at least a portion of the second information to the target group
wherein the processor is further configured to access the first information via a web site that is associated with the at least one government agency, and to automatically download the document from the web site.

12. (canceled)

13. The computing apparatus of claim 11, wherein the processor is further configured to use the at least a portion of the first information and the at least a portion of the second information to generate a report that has a predetermined format, and to route the generated report to the target group.

14. The computing apparatus of claim 11, wherein the document includes a Portable Document Format (PDF) document, and wherein the processor is further configured to use a PDF reader that is configured to extract the second information from the obtained PDF document.

15. The computing apparatus of claim 11, wherein the first information includes at least one from among identification information that relates to the first entity, a location that relates to the first entity, a filing number associated with the government agency, and a central registration depository.

16. The computing apparatus of claim 11, wherein the second information includes at least one from among information that relates to an ownership structure of the first entity, information that identifies at least one client of the first entity, information that identifies at least one affiliation of the first entity, and information that relates to an advisory service that is offered by the first entity, and demographic information that relates to the first entity.

17. The computing apparatus of claim 11, wherein the first entity includes an investment adviser firm.

18. The computing apparatus of claim 17, wherein the at least one government agency includes a United States Securities and Exchange Commission (SEC).

19. The computing apparatus of claim 18, wherein the document includes a Form ADV.

20. The computing apparatus of claim 19, wherein the target group includes at least one from among a sales team associated with a financial institution, a marketing team associated with the financial institution, a business intelligence team associated with the financial institution, and a market intelligence team associated with the financial institution.
